(19) United States
(12) Patent Application Publication
(10) Pub. No.: US 2010/0062307 A1
(43) Pub. Date: Mar. 11, 2010

(54) DIRECT OXIDATION FUEL CELL

(76) Inventors: Hideyuki UEDA, Osaka (JP); Takashi Akiyama, Osaka (JP); Hiroaki Matsuda, Osaka (JP)

Correspondence Address: MCDERMOTT WILL & EMERY LLP, 600 13TH STREET, NW, WASHINGTON, DC, 20005-3096, US

(21) Appl. No.: 12/556,167

(22) Filed: Sep. 9, 2009

(30) Foreign Application Priority Data
Sep. 9, 2008 (JP) 2008-230868

(51) Int. Cl. H01M 8/10; H01M 2/00

(52) U.S. Cl. 429/30; 429/34

(57) ABSTRACT

A direct oxidation fuel cell includes at least one unit cell. The unit cell includes: a membrane electrode assembly including an anode, a cathode, and an electrolyte membrane sandwiched therebetween; an anode-side separator having a fuel flow channel for supplying a fuel to the anode; and a cathode-side separator having an oxidant flow channel for supplying an oxidant to the cathode. The cathode includes a cathode catalyst layer in contact with the electrolyte membrane, and a cathode diffusion layer in contact with the cathode-side separator. The cathode catalyst layer includes a cathode catalyst and a polymer electrolyte, and the amount of the polymer electrolyte contained in a portion of the cathode catalyst layer facing an upstream portion of the fuel flow channel is smaller than that contained in a portion of the cathode catalyst layer facing a downstream portion of the fuel flow channel.

### FIELD OF THE INVENTION

The invention relates to direct oxidation fuel cells that directly use a fuel without reforming it into hydrogen. More particularly, the invention relates to an improvement in an electrode for a direct oxidation fuel cell.

### BACKGROUND OF THE INVENTION

With the advancement of ubiquitous network society, the demand for mobile devices such as cell phones, notebook personal computers, and digital still cameras has been remarkably increasing. As the power source for such mobile devices, it is desired to put fuel cells into practical use as early as possible. Fuel cells do not have to be recharged and permit continuous use of devices if only they get refueled.

Among fuel cells, direct oxidation fuel cells are receiving attention and studied and developed actively. Direct oxidation fuel cells generate electric power by directly supplying an organic fuel, such as methanol or dimethyl ether, to the anode for oxidation without reforming the fuel into hydrogen. An organic fuel has high theoretical energy density and can be stored easily. Also, the use of an organic fuel permits simplification of the fuel cell system.

A direct oxidation fuel cell includes a unit cell composed of a membrane electrode assembly (hereinafter referred to as an “MEA”) sandwiched between separators. The MEA typically includes an electrolyte membrane and an anode and a cathode sandwiching the electrolyte membrane. Each of the anode and the cathode includes a catalyst layer and a diffusion layer. In such a direct oxidation fuel cell, a fuel and water are supplied to the anode, and an oxidant such as oxygen is supplied to the cathode, to generate power.

For example, the electrode reactions of a direct methanol fuel cell (hereinafter referred to as a “DMFC”), which uses methanol as the fuel, are as follows.

CH₃OH+H₂O→CO₂+6H⁺+6e⁻ Anode

3/2O₂+6H⁺+6e⁻→3H₂O Cathode

At the anode, methanol reacts with water to produce carbon dioxide, protons, and electrons. The protons produced at the anode migrate to the cathode through the electrolyte membrane, and the electrons migrate to the cathode through an external circuit. At the cathode, these protons and electrons combine with oxygen to form water.

However, practical utilization of DMFCs has some problems. One of the problems relates to durability. Inside the cathode catalyst layer and/or at the interface between the cathode catalyst layer and the cathode diffusion layer, water produced by the reaction and/or transferred from the anode accumulates in liquid form with the passage of power generation time. The accumulated water impairs the diffusion of the oxidant in the cathode, resulting in increased cathodic concentration overvoltage. This is considered to be the main cause of initial deterioration of the power generation performance of DMFCs.

The initial deterioration is strongly affected by methanol crossover (hereinafter referred to as “MCO”), which is a phenomenon in which unreacted methanol passes through the electrolyte membrane and reaches the cathode. In the cathode catalyst layer, the oxidation reaction of crossover methanol occurs simultaneously with the reduction reaction of the oxidant, which is the normal electrode reaction of the cathode. Thus, particularly when high concentration methanol is used as the fuel, the amount of MCO increases with the passage of power generation time, thereby resulting in a significant increase in cathodic activation overvoltage. In addition, carbon dioxide produced by the reaction further impairs the diffusion of the oxidant, thereby causing the power generation performance to deteriorate significantly.

The initial deterioration tends to occur in the cathode-side power generation region facing the upstream of the fuel flow channel where a large amount of MCO occurs. The initial deterioration becomes evident particularly when the three-phase interface of catalyst/electrolyte/oxygen serving as the electrode reaction site is small in the above-mentioned power generation region.

To address these problems, there has been proposed a method of increasing the amount of a catalyst used in a DMFC relative to that in a solid polymer electrolyte fuel cell (PEFC), in order to increase the surface area of the catalyst (catalytic reaction site) per unit area of the catalyst layer. However, an increase in the catalyst amount leads to an increase in the thickness of the catalyst layer itself, thereby making it difficult for the oxidant to reach the reaction site inside the catalyst layer. As a result, the power generation performance deteriorates.

Hence, to solve the above-described problems, a large number of proposals have been made to improve the structure of the cathode catalyst layer itself.

For example, Japanese Laid-Open Patent Publication No. 2005-353541 (Document 1) and Japanese Laid-Open Patent Publication No. 2006-107877 (Document 2) disclose providing a cathode catalyst layer with a plurality of through-holes or vertical holes. By providing the through-holes or vertical holes, Documents 1 and 2 intend to facilitate the supply of the oxidant deep into the catalyst layer and the removal of the water from the depths of the catalyst layer even when the cathode catalyst layer is thick.

Also, Japanese Laid-Open Patent Publication No. 2006-185800 (Document 3) discloses a transfer sheet in which the polymer electrolyte concentration is changed in the thickness direction of the cathode catalyst layer such that the polymer electrolyte concentration increases toward the electrolyte membrane, as well as a method for producing the transfer sheet. Document 3 intends to provide a membrane electrode assembly in which the resistance at the interface between the catalyst layer and the electrolyte membrane is small and sufficient supply of an oxidant is possible.

However, even with the use of such conventional techniques, the amount of the three-phase interface serving as the electrode reaction site cannot be optimized in the cathode-side power generation region facing the upstream of the fuel flow channel where the amount of MCO is large. Further, in the cathode-side power generation region facing the midstream and downstream of the fuel flow channel where the amount of MCO is small, the supply of the oxidant into the catalyst layer and the removal of the water from the depths of the catalyst layer cannot be kept smooth. Therefore, according to such conventional techniques, it is difficult to obtain a catalyst layer with a small cathodic overvoltage.

Specifically, in the case of the techniques disclosed by Documents 1 and 2, the cathode-side power generation region facing the upstream of the fuel flow channel has a plurality of through-holes or vertical holes. In other words, it has large void spaces. Thus, the amount of the three-phase interface serving as the electrode reaction site becomes insufficient, and the cathodic overvoltage in this region increases. In the cathode-side power generation region facing the midstream and downstream of the fuel flow channel where the amount of MCO is small, the oxidant can easily reach the three-phase interface serving as the electrode reaction site through the through-holes or vertical holes in the catalyst layer in an early stage of power generation when the amount of produced water in the cathode is small. Hence, the power generation performance is relatively good. However, with the passage of power generation time, a large amount of produced water accumulates in the through-holes or vertical holes, which makes it difficult to supply the oxidant deep into the catalyst layer in a reliable manner. Therefore, a sharp deterioration of the power generation performance is thought to occur.

In the case of the technique disclosed by Document 3, the structure of the cathode is not designed in consideration of the impact of the change in the amount of MCO in the direction of flow of the fuel. Hence, in the cathode-side power generation region facing the upstream of the fuel flow channel, the polymer electrolyte swells with crossover methanol and the pore volume of the catalyst layer decreases. Since the swelling of the polymer electrolyte increases with the passage of power generation time, the pore volume of the catalyst layer also decreases with the passage of power generation time. In this case, the durability of the MEA is expected to lower.

The invention solves the above-discussed problems with conventional techniques and intends to provide a direct oxidation fuel cell that is excellent in power generation performance and durability.

### BRIEF SUMMARY OF THE INVENTION

The direct oxidation fuel cell of the invention includes at least one unit cell. The unit cell includes: (i) a membrane electrode assembly including an anode, a cathode, and an electrolyte membrane sandwiched between the anode and the cathode; (ii) an anode-side separator being in contact with the anode and having a fuel flow channel for supplying a fuel to the anode; and (iii) a cathode-side separator being in contact with the cathode and having an oxidant flow channel for supplying an oxidant to the cathode. The cathode includes a cathode catalyst layer in contact with the electrolyte membrane, and a cathode diffusion layer in contact with the cathode-side separator. The cathode catalyst layer includes a cathode catalyst and a polymer electrolyte. The amount of the polymer electrolyte contained in a portion of the cathode catalyst layer facing an upstream portion of the fuel flow channel is smaller than that contained in a portion of the cathode catalyst layer facing a downstream portion of the fuel flow channel. Preferably, the amount of the polymer electrolyte contained in the cathode catalyst layer gradually increases from upstream toward downstream of the fuel flow channel.

When the cathode catalyst layer includes conductive carbon particles loaded with the cathode catalyst, the weight ratio of the polymer electrolyte to the conductive carbon particles in the portion of the cathode catalyst layer facing the upstream portion of the fuel flow channel is preferably lower than that in the portion of the cathode catalyst layer facing the downstream portion of the fuel flow channel. More preferably, the weight ratio of the polymer electrolyte to the conductive carbon particles gradually increases in the cathode catalyst layer from upstream toward downstream of the fuel flow channel.

Preferably, the weight ratio of the polymer electrolyte to the conductive carbon particles is from 0.3 to 0.6 in the portion of the cathode catalyst layer facing the upstream portion of the fuel flow channel.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE SEVERAL VIEWS OF THE DRAWING

FIG. 1 is a schematic longitudinal sectional view of the structure of a unit cell included in a direct oxidation fuel cell according to an embodiment of the invention;

FIG. 2 is a schematic front view of a cathode catalyst layer included in a direct oxidation fuel cell according to Embodiment 1;

FIG. 3 is a sectional view of the cathode catalyst layer of FIG. 2 taken along line III-III;

FIG. 4 is a schematic longitudinal sectional view of another example of the cathode catalyst layer included in the direct oxidation fuel cell according to Embodiment 1;

FIG. 5 is a schematic longitudinal sectional view of still another example of the cathode catalyst layer included in the direct oxidation fuel cell according to Embodiment 1;

FIG. 6 is a schematic longitudinal sectional view of an exemplary cathode catalyst layer included in a direct oxidation fuel cell according to Embodiment 2;

FIG. 7 is a schematic longitudinal sectional view of another example of the cathode catalyst layer included in the direct oxidation fuel cell according to Embodiment 2;

FIG. 8 is a schematic longitudinal sectional view of still another example of the cathode catalyst layer included in the direct oxidation fuel cell according to Embodiment 2; and

FIG. 9 is a schematic view of the structure of an exemplary spray coater used for forming a cathode catalyst layer.

### DETAILED DESCRIPTION OF THE INVENTION

The direct oxidation fuel cell of the invention includes at least one unit cell. The unit cell includes: a membrane electrode assembly including an anode, a cathode, and an electrolyte membrane sandwiched between the anode and the cathode; an anode-side separator being in contact with the anode and having a fuel flow channel for supplying a fuel to the anode; and a cathode-side separator being in contact with the cathode and having an oxidant flow channel for supplying an oxidant to the cathode. The cathode includes a cathode catalyst layer in contact with the electrolyte membrane, and a cathode diffusion layer in contact with the cathode-side separator. The cathode catalyst layer includes a cathode catalyst and a polymer electrolyte. The amount of the polymer electrolyte contained in a portion of the cathode catalyst layer facing an upstream portion of the fuel flow channel is smaller than that contained in a portion of the cathode catalyst layer facing a downstream portion of the fuel flow channel.

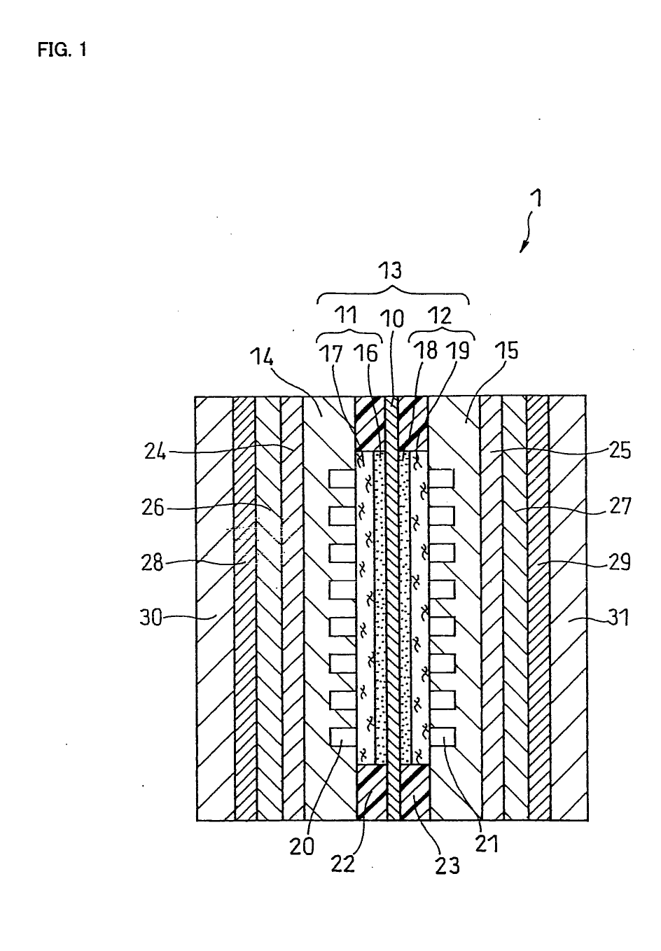

FIG. 1 is a longitudinal sectional view of a unit cell included in a fuel cell according to one embodiment of the invention.

A unit cell 1 of FIG. 1 includes: a membrane electrode assembly (MEA) 13 composed of an electrolyte membrane 10 and an anode 11 and a cathode 12 sandwiching the electrolyte membrane 10; and an anode-side separator 14 and a cathode-side separator 15 sandwiching the MEA 13.

The anode 11 includes an anode catalyst layer 16 in contact with the electrolyte membrane 10 and an anode diffusion layer 17 in contact with the anode-side separator 14. The cathode 12 includes a cathode catalyst layer 18 in contact with the electrolyte membrane 10 and a cathode diffusion layer 19 in contact with the cathode-side separator 15.

The anode-side separator 14 has, on the surface facing the anode 11, a fuel flow channel 20 for supplying a fuel and discharging the unused fuel and reaction products. The cathode-side separator 15 has, on the surface facing the cathode 12, an oxidant flow channel 21 for supplying an oxidant and discharging the unused oxidant and reaction products.

Disposed around the anode 11 and the cathode 12 are gaskets 22 and 23, respectively, which sandwich the electrolyte membrane 10 to prevent leakage of the fuel, oxidant, and reaction products. Further, in the unit cell 1 of FIG. 1, the separators 14 and 15 are sandwiched between current collector plates 24 and 25, sheet heaters 26 and 27, insulator plates 28 and 29, and end plates 30 and 31, respectively. The unit cell 1 is secured by clamping means (not shown).

In a typical fuel cell, a plurality of unit cells 1 are often connected in series.

The cathode catalyst layer 18 includes a cathode catalyst and a polymer electrolyte. For example, the cathode catalyst layer 18 is composed mainly of: conductive carbon particles loaded with catalyst metal fine particles, or catalyst metal fine part particles; and a polymer electrolyte. The catalyst metal fine particles serving as the cathode catalyst are, for example, platinum (Pt) fine particles. The polymer electrolyte contained in the cathode catalyst layer 18 is preferably the same as the material constituting the electrolyte membrane 10. For example, a perfluorocarbon sulfonic acid ionomer (e.g., Nafion (trade name), Flemion (trade name)) can be used as the polymer electrolyte contained in the cathode catalyst layer.

The cathode catalyst layer used in the invention is hereinafter described with reference to drawings.

### Embodiment 1

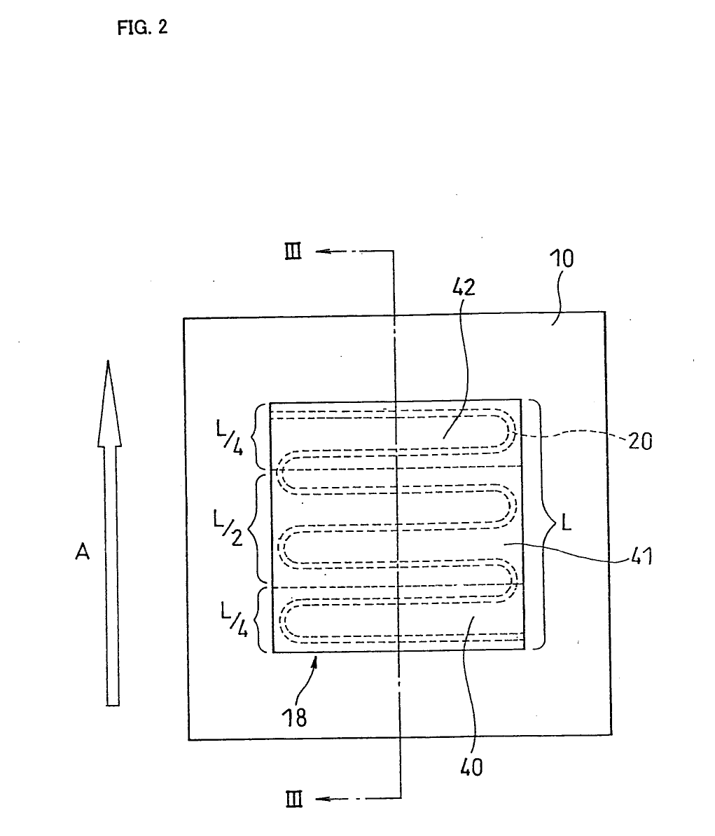

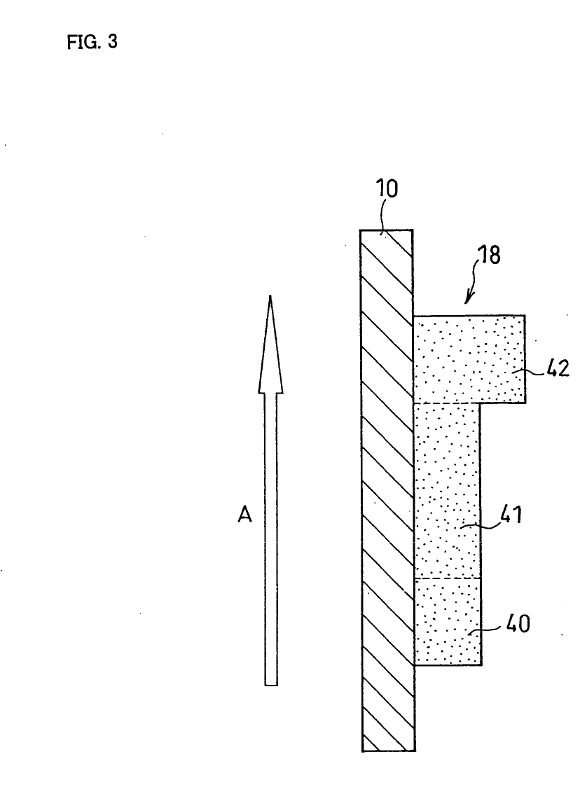

FIG. 2 is a schematic front view of a cathode catalyst layer included in a direct oxidation fuel cell according to one embodiment of the invention, and FIG. 3 is a sectional view taken along line III-III in FIG. 2. FIGS. 2 and 3 illustrate the cathode catalyst layer 18 formed on the electrolyte membrane 10. In FIG. 2, the serpentine fuel flow channel 20 which the cathode catalyst layer faces is also shown by dotted lines.

In the invention, the amount of the polymer electrolyte contained in a portion 40 of the cathode catalyst layer 18 facing an upstream portion of the fuel flow channel is smaller than that contained in at least a portion 42 facing a downstream portion of the fuel flow channel. As used herein, the amount of the polymer electrolyte refers to the amount of the polymer electrolyte contained per unit projected area of the cathode catalyst layer.

In FIG. 2, an arrow A represents the overall flow direction in which the fuel flows from upstream toward downstream of the fuel flow channel, and L represents the length of the cathode catalyst layer 18 parallel to the flow direction of the arrow A. As used herein, the portion (upstream portion) 40 of the cathode catalyst layer 18 facing an upstream portion of the fuel flow channel refers to the region of the cathode catalyst layer that is positioned opposite an upstream portion of the fuel flow channel so as to have a length in the flow direction of the arrow A of approximately L/4 (region having an area which is approximately one fourth of the cathode catalyst layer 18). As used herein, the portion (downstream portion) 42 of the cathode catalyst layer 18 facing a downstream portion of the fuel flow channel refers to the region of the cathode catalyst layer that is positioned opposite a downstream portion of the fuel flow channel so as to have a length in the flow direction of the arrow A of approximately L/4 (region having an area which is approximately one fourth of the cathode catalyst layer 18).

As used herein, unit projected area of the cathode catalyst layer refers to unit area (cm²) of the cathode catalyst layer seen from the direction of the normal to the main surface of the cathode catalyst layer.

In the invention, instead of distributing the polymer electrolyte evenly throughout the cathode catalyst layer, the amount of the polymer electrolyte contained in the cathode-side power generation region facing the upstream of the fuel flow channel with a large amount of MCO (i.e., the upstream portion 40 of the cathode catalyst layer 18) is made smaller than that contained in the cathode-side power generation region facing the downstream of the fuel flow channel (i.e., the downstream portion 42 of the cathode catalyst layer 18), as described above. It is thus possible to suppress a significant reduction in the pore volume of the catalyst layer due to swelling of the polymer electrolyte with crossover methanol. Further, in the cathode-side power generation region facing the downstream of the fuel flow channel with a small amount of MCO, since the amount of the polymer electrolyte is optimized, both good oxidant diffusion and good proton conductivity can be obtained. As a result, cathodic overvoltage can be reduced, and the durability of the fuel cell can be improved.

In this embodiment, or example as a illustrated in FIG. 3, by making the upstream portion 40 of the cathode catalyst layer 18 thinner than the downstream portion 42, the amount of the polymer electrolyte contained in the upstream portion 40 can be made less than that contained in the downstream portion 42. In the cathode catalyst layer of FIG. 3, the thickness of a portion (midstream portion) 41 of the cathode catalyst layer 18 facing the midstream of the fuel flow channel is made equal to that of the upstream portion 40.

The structure of the cathode catalyst layer 18 is not limited to that as illustrated in FIG. 3 if the amount of the polymer electrolyte contained in the upstream portion 40 of the cathode catalyst layer 18 is smaller than that contained in the downstream portion 42 of the cathode catalyst layer 18.

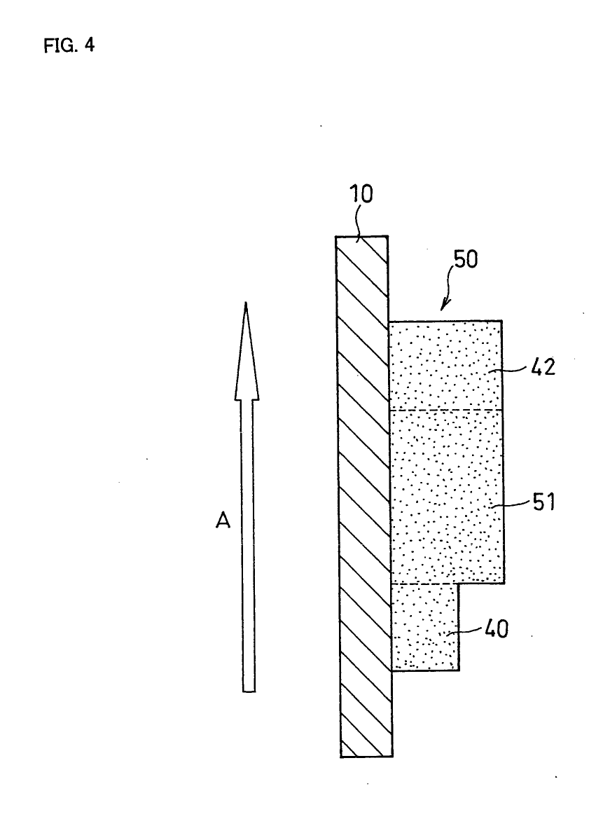

For example, the cathode catalyst layer may have a structure as illustrated in FIG. 4. In FIG. 4, the same components as those in FIGS. 2 and 3 are given the same numbers.

In a cathode catalyst layer 50 of FIG. 4, the thickness of a portion (midstream portion) 51 facing the midstream of the fuel flow channel is made equal to that of the downstream portion 42. That is, the midstream portion 51 is made thicker than the upstream portion 40.

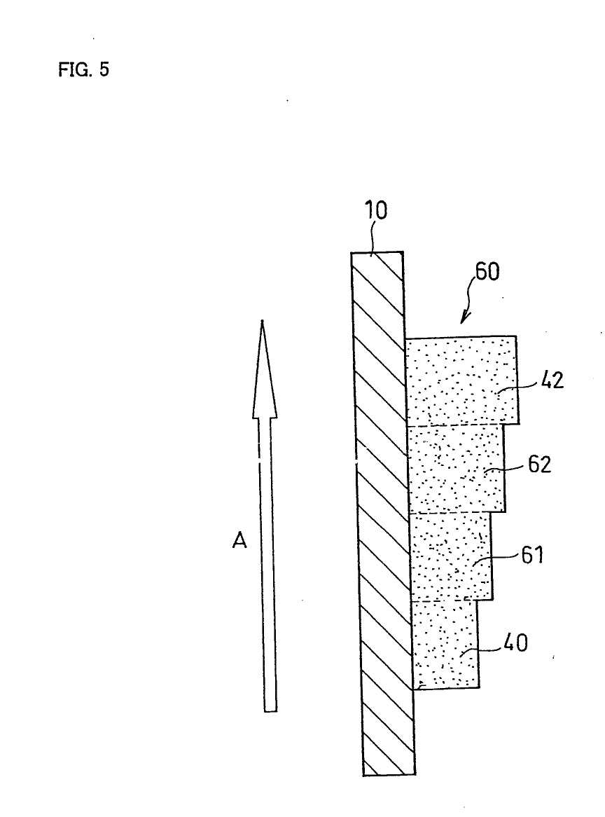

Alternatively, the amount of the polymer electrolyte contained in the cathode catalyst layer may be gradually increased from upstream toward downstream of the fuel flow channel. FIG. 5 shows an example. In FIG. 5, also, the same components as those in FIGS. 2 and 3 are given the same numbers.

The thickness of a cathode catalyst layer 60 of FIG. 5 is increased stepwise from upstream toward downstream of the fuel flow channel. Specifically, the midstream portion of the cathode catalyst layer 60 is divided in two portions, i.e., a first midstream portion 61 and a second midstream portion 62. In the direction of the arrow A, the upstream portion 40, the first midstream portion 61, the second midstream portion 62, and the downstream portion 42 are made thicker in this order. That is, the amount of the polymer electrolyte contained in the cathode catalyst layer is increased stepwise from upstream toward downstream of the fuel flow channel. The lengths of the first midstream portion 61 and the second midstream portion 62 parallel to the arrow A may be the same or different.

Also, the thickness of the cathode catalyst layer may be continuously increased from upstream toward downstream of the fuel flow channel in order to continuously increase the amount of the polymer electrolyte contained in the cathode catalyst layer from upstream toward downstream of the fuel flow channel.

In particular, it is preferable to increase the amount of the polymer electrolyte contained in the cathode catalyst layer gradually (stepwise or continuously) from upstream toward downstream of the fuel flow channel. In such a structure, the amount of the polymer electrolyte contained in the cathode catalyst layer is optimized according to the amount of MCO which differs between the upstream and downstream sides of the fuel flow channel. As a result, in the cathode-side power generation region facing the midstream of the fuel flow channel, it is possible to ensure proton conductivity while suppressing a decrease in the pore volume of the catalyst layer due to swelling of the polymer electrolyte. It is therefore possible to make cathodic overvoltage small and stable.

When the amount of the polymer electrolyte contained in the cathode catalyst layer gradually increases from upstream toward downstream of the fuel flow channel, the rate of increase of the weight of the polymer electrolyte is preferably 0.05 to 0.10 mg/cm in the direction of the arrow A.

### Embodiment 2

In this embodiment, the weight ratio of the polymer electrolyte to the conductive carbon particles in the portion (upstream portion) of the cathode catalyst layer facing the upstream of the fuel flow channel is lower than that in the portion (downstream portion) of the cathode catalyst layer facing the downstream of the fuel flow channel. In this embodiment, similarly to Embodiment 1, the amount of the polymer electrolyte contained in the upstream portion of the cathode catalyst layer is smaller than that contained in the downstream portion of the cathode catalyst layer. In this embodiment, the portion (upstream portion) of the cathode catalyst layer facing the upstream of the fuel flow channel, the portion (downstream portion) of the cathode catalyst layer facing the downstream of the fuel flow channel, and the amount of the polymer electrolyte are defined in the same manner as in Embodiment 1. The weight of the conductive carbon particles refers to the weight of the conductive carbon particles contained per unit projected area of the cathode catalyst layer.

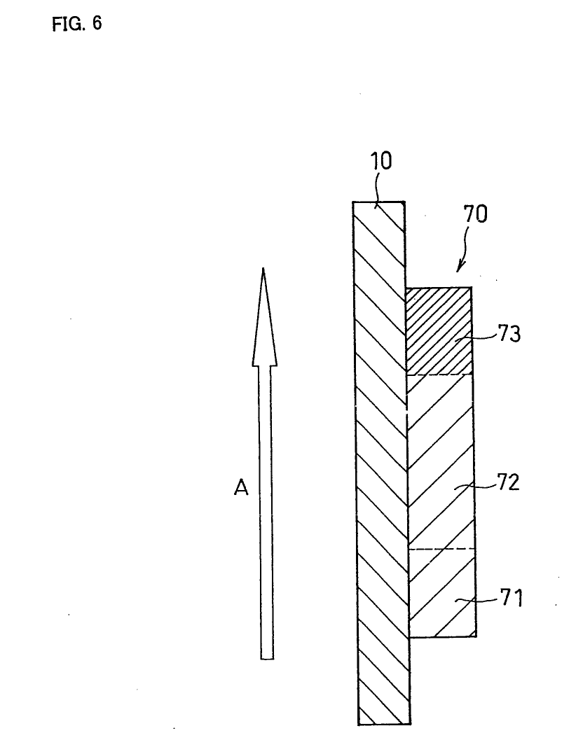

FIG. 6 illustrates an exemplary cathode catalyst layer included in a direct oxidation fuel cell according to this embodiment. In FIG. 6, the same components as those in FIG. 1 are given the same numbers.

A cathode catalyst layer 70 of FIG. 6 is composed mainly of a polymer electrolyte and conductive carbon particles loaded with a cathode catalyst The cathode catalyst contained in the cathode catalyst layer 70 can be, for example, platinum (Pt) fine particles. The polymer electrolyte contained in the cathode catalyst layer 70 is preferably the same as the material constituting the electrolyte membrane 10.

As described above, in this embodiment, the weight ratio Wu of the polymer electrolyte to the conductive carbon particles in a portion 71 (upstream portion) of the cathode catalyst layer 70 facing the upstream of the fuel flow channel is lower than the weight ratio Wd of the polymer electrolyte to the conductive carbon particles in a portion 73 (downstream portion) of the cathode catalyst layer 70 facing the downstream of the fuel flow channel. It should be noted that the above-mentioned weight of the conductive carbon particles do not include the weight of the cathode catalyst.

The method of making the ratio Wu lower than the ratio Wd is not particularly limited. For example, in the cathode catalyst layer of FIG. 6, the ratio Wu is made lower than the ratio Wd by using the same weight of the conductive carbon particles in the upstream portion 71 and the downstream portion 73, and making the amount of the polymer electrolyte contained in the upstream portion 71 smaller than that contained in the downstream portion 73. In FIG. 6, the weight ratio Wm of the polymer electrolyte to the conductive carbon particles in a midstream portion 72 of the cathode catalyst layer 70 is made equal to the ratio Wu.

Without reducing the amounts of the cathode catalyst and conductive carbon particles contained in the upstream portion of the cathode catalyst layer (i.e., while making the amounts of the cathode catalyst and conductive carbon particles uniform throughout the cathode catalyst layer), the amount of the polymer electrolyte contained in the upstream portion of the cathode catalyst layer is made smaller than that contained in the downstream portion of the cathode catalyst layer. That is, the ratio Wu is made lower than the ratio Wd. By this, it is possible to suppress a significant reduction in the pore volume of the catalyst layer due to swelling of the polymer electrolyte with crossover methanol. It is also possible to secure three-phase interface necessary for the reduction reaction of the oxidant and the oxidation reaction of the crossover methanol to proceed simultaneously. Further, in the cathode-side power generation region facing the downstream of the fuel flow channel with a small amount of MCO, the balance between the diffusion of the oxidant and the proton conductivity can be further optimized. As a result, cathodic overvoltage is significantly reduced, and thus the durability of the fuel cell can be further enhanced.

The ratio Wu is preferably from 0.3 to 0.6. When the ratio Wu is in this range, it is possible to prevent the amount of the polymer electrolyte contained in the cathode catalyst layer from becoming excessive. It is therefore possible to avoid problems such as decreased proton conductivity due to decreased pore volume of the cathode catalyst layer and shortage of the polymer electrolyte. As a result, cathodic overvoltage can be significantly reduced.

In this embodiment, the structure of the cathode catalyst layer is not limited to that as illustrated in FIG. 6 if the ratio Wu is smaller than the ratio Wd.

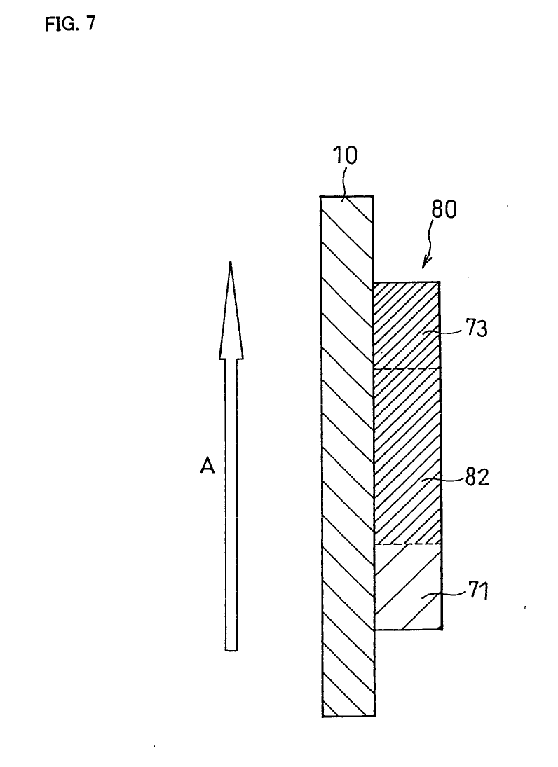

For example, the cathode catalyst layer may have a structure as illustrated in the cross-sectional view of FIG. 7. In FIG. 7, the same components as those in FIG. 6 are given the same numbers.

In a cathode catalyst layer 80 of FIG. 7, the weight ratio Wm of the polymer electrolyte to the conductive carbon particles in a portion 82 (midstream portion) facing the midstream of the fuel flow channel is made equal to the ratio Wd. That is, the ratio Wm is made higher than the ratio Wu.

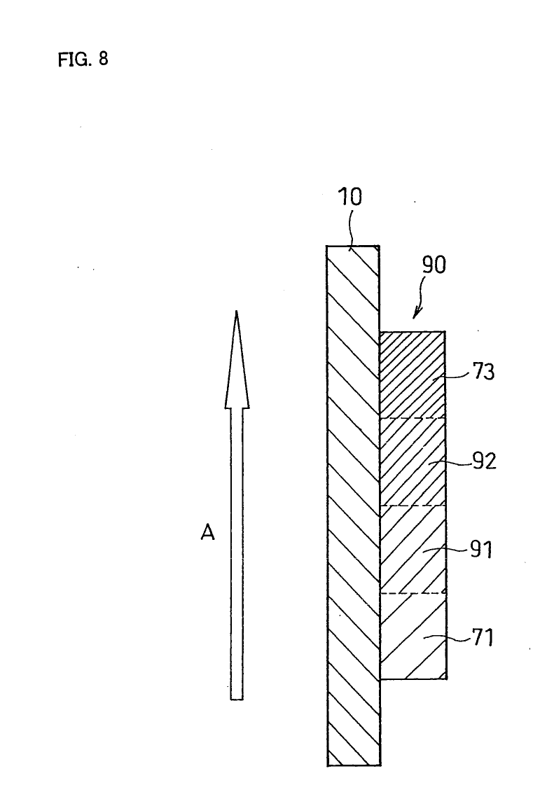

Alternatively, the weight ratio W of the polymer electrolyte to the conductive carbon particles may be gradually increased from upstream toward downstream of the fuel flow channel. FIG. 8 shows an example. In FIG. 8, also, the same components as those in FIG. 6 are given the same numbers.

In a cathode catalyst layer 90 of FIG. 8, the ratio W increases stepwise from upstream toward downstream of the fuel flow channel. Specifically, the midstream portion of the cathode catalyst layer 90 is divided into two portions, i.e., a first midstream portion 91 and a second midstream portion 92. In the direction of the arrow A, the ratio W is increased from the upstream portion 71, the first midstream portion 91, the second midstream portion 92, and the downstream portion 73 in this order. The lengths of the first midstream portion 91 and the second midstream portion 92 parallel to the arrow A may be the same or different.

Alternatively, in the cathode catalyst layer, the ratio W may be continuously increased from upstream toward downstream of the fuel flow channel.

In particular, it is preferable to increase the ratio W gradually (stepwise or continuously) from upstream toward downstream of the fuel flow channel. In such a structure, the ratio of the polymer electrolyte contained in the cathode catalyst layer is optimized according to the amount of MCO which differs between the upstream and downstream sides of the fuel flow channel. As a result, in the cathode-side power generation region facing the midstream of the fuel flow channel, it is possible to ensure proton conductivity while suppressing a decrease in the pore volume of the catalyst layer due to swelling of the polymer electrolyte. It is therefore possible to make cathodic overvoltage small and stable.

When the ratio W in the cathode catalyst layer gradually increases from upstream toward downstream of the fuel flow channel, the rate of increase of the ratio W is preferably 0.05 to 0.10/cm in the direction of the arrow A.

As described above, in the invention, the weight of the polymer electrolyte in the cathode catalyst layer per unit projected area and the weight ratio of the polymer electrolyte to the conductive carbon particles are optimized in consideration of the direction of flow of the fuel (the change in the amount of MCO). It is thus possible to suppress a decrease in the pore volume of the cathode catalyst layer due to swelling of the polymer electrolyte while ensuring proton conductivity. As a result, it is possible to provide a catalyst layer with a small cathodic overvoltage. Therefore, the invention can provide a direct oxidation fuel cell that is excellent in power generation performance and durability.

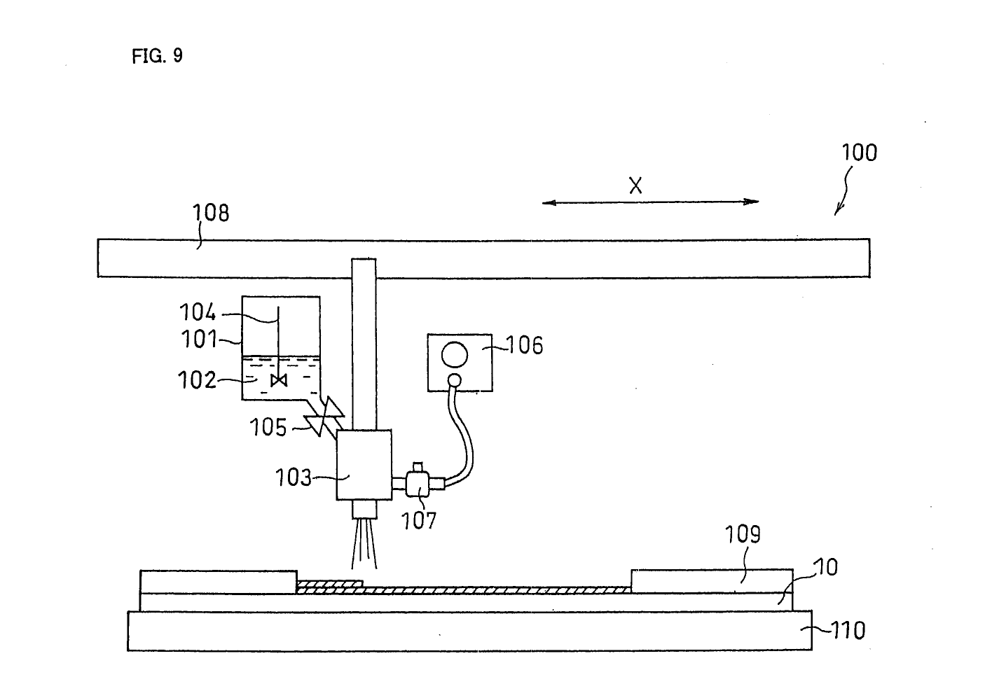

The cathode catalyst layers shown in Embodiment 1 and 2 can be produced using, for example, a spray coater 100 as illustrated in FIG. 9. FIG. 9 is a schematic view of the structure of a spray coater for forming a cathode catalyst layer.

The spray coater 100 includes a tank 101 containing a cathode catalyst ink 102 and a spray gun 103.

In the tank 101, the cathode catalyst ink 102 is stirred by a stirrer 104, thus being constantly flowing. The cathode catalyst ink 102 is fed to the spray gun 103 through an open/close valve 105 and sprayed from the spray gun 103 together with spray gas. The spray gas is fed to the spray gun 103 through a gas pressure adjustor 106 and a gas flow rate adjustor 107. As the spray gas, for example, nitrogen gas can be used.

In the spray coater 100, the spray gun 103 can be moved by an actuator 108 from a desired position and at a desired speed on the plane perpendicular to the sheet of drawing in two directions: the direction of the X axis parallel to the arrow X and the direction of the Y axis perpendicular to the X axis.

The spray gun 103 is disposed above the electrolyte membrane 10. By moving the spray gun 103 while causing it to spray the cathode catalyst in 102, a cathode catalyst layer can be formed on the electrolyte membrane 10. The area of the electrolyte membrane 10 coated with the cathode catalyst ink 102 can be adjusted by using a mask 109.

In forming a cathode catalyst layer, it is preferable to control the surface temperature of the electrolyte membrane 10. In the spray coater 100, the surface temperature of the electrolyte membrane 10 is controlled by a heater 110 installed so as to come into contact with the electrolyte membrane 10.

As described above, in the spray coater 100, while the spray gun 103 is being moved to a desired position, the cathode catalyst ink 102 can be sprayed. That is, the thickness of the cathode catalyst layer can be changed at a desired position thereof. Hence, the use of the spray coater 100 permits easy formation of the cathode catalyst layers shown in Embodiment 1.

Also, the cathode catalyst layers shown in Embodiment 2 can be easily produced by gradually changing the composition (weight ratio of the polymer electrolyte to the conductive carbon particles) of the cathode catalyst ink 102 introduced into the tank 101 and applying the cathode catalyst inks of different compositions onto predetermined positions.

It should be noted that FIG. 9 illustrates a process of forming the portion of the cathode catalyst layer that is to face the downstream of the fuel flow channel, in which the cathode catalyst ink 102 is being sprayed from the spray gun 103.

Referring to FIG. 1 again, components other than the cathode catalyst layer are described.

The cathode diffusion layer 19 can be a conductive porous substrate which allows an oxidant to be diffused and water produced by power generation to be removed therethrough while having electronic conductivity. Examples of such conductive porous substrates include carbon paper and carbon cloth. Also, such a conductive porous substrate may be subjected to a water-repellent treatment by a known technique. Further, a water-repellent carbon layer (not shown) may be formed on the surface of the conductive porous substrate on the cathode catalyst layer 18 side.

The anode catalyst layer 16 is composed mainly of: conductive carbon particles loaded with catalyst metal fine particles, or catalyst metal fine particles; and a polymer electrolyte. The catalyst metal fine particles contained in the anode catalyst layer 16 can be, for example, platinum-ruthenium (Pt—Ru) alloy fine particles. The polymer electrolyte contained in the anode catalyst layer 16 is preferably the same as the material constituting the electrolyte membrane 10.

The anode diffusion layer 17 can be a conductive porous substrate which allows a fuel to be diffused and carbon dioxide produced by power generation to be removed therethrough while having electronic conductivity. Examples of such conductive porous substrates include carbon paper and carbon cloth. Also, such a conductive porous substrate may be subjected to a water-repellent treatment by a known technique. Further, a water-repellent carbon layer (not shown) may be formed on the surface of the conductive porous substrate on the anode catalyst layer 16 side.

The electrolyte membrane 10 preferably has good properties such as proton conductivity, heat resistance, and chemical stability. The material constituting the electrolyte membrane 10 (polymer electrolyte) is not particularly limited if the electrolyte membrane 10 has the above-described properties.

The material of the separators 14 and 15 is not particularly limited if the separators 14 and 15 have gas tightness, electron conductivity, and electrochemical stability. Also, the shapes of the fuel flow channel 20 and the oxidant flow channel 21 are not particularly limited either.

The current collectors 24 and 25, the sheet heaters 26 and 27, the insulator plates 28 and 29, and the end plates 30 and 31 can be made of materials known in the art.

The amount of a polymer electrolyte contained in a cathode catalyst layer can be measured, for example, as follows. A predetermined portion (e.g., upstream portion) of a cathode catalyst layer which contains a predetermined polymer electrolyte (e.g., perfluorocarbon sulfonic acid ionomer), a cathode catalyst, and conductive carbon particles loaded with the cathode catalyst and which is formed on an electrolyte membrane is scraped off to obtain a sample. The weight of the sample is measured with a micro-balance. The sample is then burned with an automatic furnace (e.g., AQF-100 available from Mitsubishi Chemical Corporation). The gas produced is absorbed by an absorbent. The amount of F ions contained in the absorbent is measured with an ion chromatograph (e.g., ICS-1500 available from Dionex Corporation). From the measured amount of F ions, the amount of the polymer electrolyte contained in the predetermined portion of the cathode catalyst layer can be obtained. Using the obtained value, the amount of the polymer electrolyte contained per square centimeter of the predetermined portion of the cathode catalyst layer can be obtained.

The amount of a cathode catalyst contained in a cathode catalyst layer can be measured, for example, as follows. In the same manner as described above, a predetermined portion (e.g., upstream portion) of a cathode catalyst layer which contains a predetermined polymer electrolyte (e.g., perfluorocarbon sulfonic acid ionomer), a cathode catalyst, and conductive carbon particles loaded with the cathode catalyst and which is formed on an electrolyte membrane is scraped off to obtain a sample. The weight of the sample is measured with a micro-balance. The sample is then dissolved in aqua regia and the insoluble matter is filtered out. The filtrate was mixed with water to prepare a solution of a predetermined amount (e.g., 100 ml). The amount of the cathode catalyst contained in the solution is measured with an inductively coupled plasma-atomic emission spectrometer (ICP-AES; e.g., ICAP 6300 available from Thermo Fisher Scientific Inc.). Using the value obtained, the amount of the cathode catalyst contained in the predetermined portion of the cathode catalyst layer per square centimeter can be obtained.

The amount of the conductive carbon particles contained in the predetermined portion of the cathode catalyst layer per square centimeter can be obtained, for example, by subtracting the above-mentioned amounts of the polymer electolyte and the cathode catalyst contained in the predetermined portion of the cathode catalyst layer per square centimeter from the weight of the predetermined portion of the cathode catalyst layer per square centimeter.

### EXAMPLES

The invention is hereinafter described in detail by way of Examples. These Examples, however, are not to be construed as limiting in any way the invention.

### Example 1

A fuel cell as illustrated in FIG. 1 was produced.

The cathode catalyst layer 18 was prepared in the following manner. Pt with a mean particle diameter of 3 nm was used as the cathode catalyst. The cathode catalyst was supported on conductive carbon particles with a mean primary particle diameter of 30 nm. Carbon black (Ketjen black EC available from Mitsubishi Chemical Corporation) was used as the conductive carbon particles. The Pt content was set to 46% by weight of the total weight of the conductive carbon particles and Pt.

The conductive carbon particles loaded with the cathode catalyst were ultrasonically dispersed in an aqueous solution of isopropanol, and the resultant dispersion was mixed with an aqueous solution containing 5% by weight of a polymer electrolyte. The resultant mixture was stirred with a disperser to prepare a cathode catalyst ink A. The weight ratio of the polymer electrolyte to the conductive carbon particles in the cathode catalyst ink A was set to 0.40. As the polymer electrolyte, a perfluorocarbonsulfonic acid ionomer (Flemion available from Asahi Glass Co., Ltd.) was used.

Next, using the spray coater illustrated in FIG. 9, the cathode catalyst layer 18 as illustrated in FIGS. 2 and 3 was formed in a size of 6 cm×6 cm on the electrolyte membrane 10. As the electrolyte membrane 10, a perfluoroalkylsulfonic acid ion-exchange membrane (Nafion 112 (trade name) available from E. I. du Pont de Nemours and Company) with a size of 12 cm×12 cm was used.

First, the cathode catalyst ink A was applied 30 times onto the portion of the electrolyte membrane 10 corresponding to the power generation region (6 cm×6 cm). Thereafter, the cathode catalyst ink A was further applied 9 times only onto the portion (6 cm×1.5 cm) of the electrolyte membrane 10 which was to face the downstream of the fuel flow channel, in order to form the cathode catalyst layer 18.

The spray coating conditions were as follows. The center-to-center distance between adjacent portions to be coated with the cathode catalyst ink A sprayed from the spray gun 103 in the width direction was set to 10 mm. Every time the ink was applied, the start position of spray coating was shifted in the direction of the X axis by 1 mm (an offset of 1 mm). The spray gun 103 was moved at a speed of 60 mm/sec. Nitrogen gas was used as the spray gas and sprayed at a pressure of 0.15 MPa. The surface temperature of the electrolyte membrane 10 during the spray coating was set to 65° C.

The amount of the Pt catalyst contained in each of the upstream portion 40 and the midstream portion 41 of the cathode catalyst layer 18 was 1.05 mg/cm², and the amount of the Pt catalyst contained in the downstream portion 42 of the cathode catalyst layer 18 was 1.37 mg/cm². The amount of the Pt catalyst refers to the weight of the Pt catalyst contained in the cathode catalyst layer per unit projected area (unit area of the catalyst layer seen from the direction of the normal to the main surface of the catalyst layer).

The amount of the conductive carbon particles contained in each of the upstream portion 40 and the midstream portion 41 of the cathode catalyst layer 18 was 1.23 mg/cm², and the amount of the conductive carbon particles contained in the downstream portion 42 of the cathode catalyst layer 18 was mg/cm². The amount of the conductive carbon particles refers to the weight of the conductive carbon particles contained in the cathode catalyst layer per unit projected area (unit area of the catalyst layer seen from the direction of the normal to the main surface of the catalyst layer).

The amount of the polymer electrolyte contained in each of the upstream portion 40 and the midstream portion 41 of the cathode catalyst layer 18 was 0.49 mg/cm², and the amount of the polymer electrolyte contained in the downstream portion 42 of the cathode catalyst layer 18 was 0.64 mg/cm².

The anode catalyst layer was prepared in the following manner.

Pt—Ru alloy fine particles (Pt:Ru weight ratio=2:1) having a mean particle diameter of 3 nm was used as the anode catalyst.

The anode catalyst was ultrasonically dispersed in an aqueous solution of isopropanol, and the resultant dispersion was mixed with an aqueous solution containing 5% by weight of a polymer electrolyte. The resultant mixture was stirred with a disper to prepare an anode catalyst ink. The weight ratio of the Pt—Ru alloy fine particles to the polymer electrolyte in the anode catalyst ink was set to 2:1. As the polymer electrolyte, a perfluorocarbonsulfonic acid ionomer (Flemion available from Asahi Glass Co., Ltd.) was used.

Next, the anode catalyst ink was applied by a doctor blade method onto the other surface of the electrolyte membrane 10 from the surface with the cathode catalyst layer 18 formed thereon, so that the anode catalyst layer 16 was formed so as to face the cathode catalyst layer 18. The anode catalyst layer 16 had a size of 6 cm×6 cm, and the amount of the Pt—Ru catalyst contained in the anode catalyst layer was 6.5 mg/cm². The amount of the Pt—Ru catalyst refers to the weight of the Pt—Ru catalyst contained in the anode catalyst layer per unit projected area (unit area of the catalyst layer seen from the direction of the normal to the main surface of the catalyst layer).

In this way, a catalyst coated membrane (CCM) was obtained.

Next, the cathode diffusion layer 19 was laminated on the cathode catalyst layer 18, and the anode diffusion layer 17 was laminated on the anode catalyst layer 16. The cathode diffusion layer 19 and the anode diffusion layer 17 had a size of 6 cm×6 cm. As the cathode diffusion layer 19, a carbon cloth with a water-repellent carbon layer formed on one surface thereof (LT2500W available from E-TEK) was used. As the anode diffusion layer 17, a carbon paper (TGP-H090 available from Toray Industries Inc.) was used. One surface of the carbon paper was provided with a water-repellent carbon layer (polytetrafluoroethylene (PTFE) content: 40% by weight) having a thickness of approximately 30 μm. The cathode diffusion layer 19 and the anode diffusion layer 17 were disposed such that their carbon layers were in contact with the catalyst layers.

The resultant laminate was hot pressed at 130° C. and 4 MPa for 3 minutes to bond the catalyst layers and the diffusion layers together, thereby producing the anode 11 and the cathode 12.

Next, the gaskets 22 and 23 were thermally bonded at 130° C. and 4 MPa for 5 minutes to the electrolyte membrane 10 around the anode 11 and the cathode 12, respectively, so as to sandwich the electrolyte membrane 10, thereby producing the membrane-electrode assembly (MEA) 13. Each of the gaskets had a three-layer structure composed of a polyetherimide intermediate layer sandwiched between silicone rubber layers.

The MEA 13 thus obtained was sandwiched between the separators 14 and 15, the current collector plates 24 and 25, the sheet heaters 26 and 27, the insulator plates 28 and 29, and the end plates 30 and 31, all of which had outer dimensions of 12 cm×12 cm, and then secured with clamping rods. The clamping pressure was set to 12 kgf/cm² per area of the separator.

The separators 14 and 15 were made from a resin-impregnated graphite material of 4 mm in thickness (G347B available from TOKAI CARBON CO., LTD.) and had the serpentine flow channels 20 and 21, respectively, which had a width of 1.5 mm and a depth of 1 mm. Each of the current collector plates 24 and 25 was a gold-plated stainless steel plate. Each of the sheet heaters 26 and 27 was a SAMICONE heater (available from SAKAGUCHI E.H. VOC CORP.).

The direct oxidation fuel cell produced in the above manner was referred to as a fuel cell A.

### Example 2

Using the spray coater of FIG. 9, the cathode catalyst ink A was applied 30 times onto the whole power generation region (6 cm×6 cm) in the thickness direction. Thereafter, the cathode catalyst ink A was applied 9 times onto the portion (6 cm×4.5 cm) which was to face the midstream and downstream of the fuel flow channel, to form a cathode catalyst layer as illustrated in FIG. 4. Except for the above, a fuel cell B was produced in the same manner as in Example 1.

The amount of the Pt catalyst contained in the upstream portion of the cathode catalyst layer was 1.05 mg/cm², and the amount of the Pt catalyst contained in each of the midstream portion and downstream portion was 1.37 mg/cm².

The amount of the conductive carbon particles contained in the upstream portion of the cathode catalyst layer was 1.23 mg/cm², and the amount of the conductive carbon particles contained in each of the midstream portion and downstream portion was 1.60 mg/cm².

The amount of the polymer electrolyte contained in the upstream portion of the cathode catalyst layer was 0.49 mg/cm², and the amount of the polymer electrolyte contained in each of the midstream portion and downstream portion was 0.64 mg/cm².

### Example 3

Using the spray coater of FIG. 9, the cathode catalyst ink A was applied 30 times onto the whole power generation region (6 cm×6 cm) in the thickness direction. Subsequently, the cathode catalyst ink A was applied 3 times onto the portion (6 cm×4.5 cm) which was to face the midstream and downstream of the fuel flow channel. Thereafter, the cathode catalyst ink A was applied 3 times onto the portion (6 cm×3 cm) which was to face the downstream half of the midstream (second midstream portion) and the downstream of the fuel flow channel. Lastly, the cathode catalyst ink A was applied 3 times only onto the portion (6 cm×1.5 cm) which was to face the downstream of the fuel flow channel. In this way, a cathode catalyst layer as illustrated in FIG. 5 was formed. Except for the above, a fuel cell C was produced in the same manner as in Example 1.

The amount of the Pt catalyst contained in the upstream portion of the cathode catalyst layer was 1.05 mg/cm². The amount of the Pt catalyst contained in the first midstream portion was 1.16 mg/cm², and the amount of the Pt catalyst contained in the second midstream portion was 1.26 mg/cm². The amount of the Pt catalyst contained in the downstream portion was 1.37 mg/cm².

The amount of the conductive carbon particles contained in the upstream portion of the cathode catalyst layer was 1.23 mg/cm². The amount of the conductive carbon particles contained in the first midstream portion was 1.36 mg/cm², and the amount of the conductive carbon particles contained in the second midstream portion was 1.48 mg/cm². The amount of the conductive carbon particles contained in the downstream portion was 1.60 mg/cm².

The amount of the polymer electrolyte contained in the upstream portion of the cathode catalyst layer was 0.49 mg/cm². The amount of the polymer electrolyte contained in the first midstream portion was 0.54 mg/cm², and the amount of the polymer electrolyte contained in the second midstream portion was 0.59 mg/cm². The amount of the polymer electrolyte contained in the downstream portion was 0.64 mg/cm².

### Example 4

A cathode catalyst ink B was prepared in the same manner as in Example 1 except that the weight ratio of the polymer electrolyte to the conductive carbon particles was set to 0.60. Likewise, a cathode catalyst ink C was prepared in the same manner as in Example 1 except that the weight ratio of the polymer electrolyte to the conductive carbon particles was set to 0.35.

A perfluorocarbonsulfonic acid ionomer (Flemion available from Asahi Glass Co., Ltd.) was used as the polymer electrolyte contained in the cathode catalyst inks B and C.

Using the spray coater of FIG. 9, the cathode catalyst ink C was applied 35 times onto the portion (6 cm×4.5 cm) which was to face the upstream and midstream of the fuel flow channel. Subsequently, the cathode catalyst ink B was applied 35 times only onto the portion (6 cm×1.5 cm) which was to face the downstream of the fuel flow channel, to form a cathode catalyst layer as illustrated in FIG. 6. Except for the above, a fuel cell D was produced in the same manner as in Example 1.

The amount of the Pt catalyst contained in each of the upstream portion, the midstream portion, and the downstream portion of the cathode catalyst layer was 1.23 mg/cm².

The amount of the conductive carbon particles contained in each of the upstream portion, the midstream portion, and the downstream portion of the cathode catalyst layer was 1.44 mg/cm².

The amount of the polymer electrolyte contained in each of the upstream portion and the midstream portion of the cathode catalyst layer was 0.50 mg/cm², and the amount of the polymer electrolyte contained in the downstream portion was 0.86 mg/cm².

### Example 5

Using the spray coater of FIG. 9, the cathode catalyst ink C was applied 35 times only onto the portion (6 cm×1.5 cm) which was to face the upstream of the fuel flow channel. Subsequently, the cathode catalyst ink B was applied 35 times only onto the portion (6 cm×4.5 cm) which was to face the midstream and the downstream of the fuel flow channel, to form a cathode catalyst layer as illustrated in FIG. 7. Except for the above, a fuel cell E was produced in the same manner as in Example 4.

The amount of the Pt catalyst contained in each of the upstream portion, the midstream portion, and the downstream portion of the cathode catalyst layer was 1.23 mg/cm².

The amount of the conductive carbon particles contained in each of the upstream portion, the midstream portion, and the downstream portion of the cathode catalyst layer was 1.44 mg/cm².

The amount of the polymer electrolyte contained in the upstream portion of the cathode catalyst layer was 0.50 mg/cm², and the amount of the polymer electrolyte contained in each of the midstream portion and the downstream portion was 0.86 mg/cm².

### Example 6

A cathode catalyst ink D was prepared in the same manner as in Example 4 except that the weight ratio of the polymer electrolyte to the conductive carbon particles was set to 0.50. Likewise, a cathode catalyst ink E was prepared in the same manner as in Example 4 except that the weight ratio of the polymer electrolyte to the conductive carbon particles was set to 0.40.

Using the spray coater of FIG. 9, the cathode catalyst ink C was applied 35 times only onto the portion (6 cm×1.5 cm) which was to face the upstream of the fuel flow channel. Subsequently, the cathode catalyst ink E was applied 35 times only onto the portion (6 cm×1.5 cm) which was to face the first midstream of the fuel flow channel. Subsequently, the cathode catalyst ink D was applied 35 times only onto the portion (6 cm×1.5 cm) which was to face the second midstream of the fuel flow channel. Thereafter, the cathode catalyst ink B was applied 35 times only onto the portion (6 cm×1.5 cm) which was to face the downstream of the fuel flow channel, to form a cathode catalyst layer as illustrated in FIG. 8. Except for the above, a fuel cell F was produced in the same manner as in Example 4.

The amount of the Pt catalyst contained in each of the upstream portion, the first midstream portion, the second midstream portion, and the downstream portion of the cathode catalyst layer was 1.23 mg/cm².

The amount of the conductive carbon particles contained in each of the upstream portion, the midstream portion, and the downstream portion of the cathode catalyst layer was 1.44 mg/cm².

The amount of the polymer electrolyte contained in the upstream portion of the cathode catalyst layer was 0.50 mg/cm². The amount of the polymer electrolyte contained in the first midstream portion was 0.58 mg/cm², and the amount of the polymer electrolyte contained in the second midstream portion was 0.72 mg/cm². The amount of the polymer electrolyte contained in the downstream portion was 0.86 mg/cm².

### Comparative Example 1

Using the spray coater of FIG. 9, the cathode catalyst ink A was applied 39 times onto the whole power generation region (6 cm×6 cm) in the thickness direction thereof, to form a cathode catalyst layer. Except for the above, a comparative fuel cell 1 was produced in the same manner as in Example 1.

The amount of the Pt catalyst contained in the cathode catalyst layer was 1.37 mg/cm², the amount of the conductive carbon particle was 1.60 mg/cm², and the amount of the polymer electrolyte was 0.64 mg/cm².

### Comparative Example 2

Using the spray coater of FIG. 9, the cathode catalyst ink A was applied 30 times onto the whole power generation region (6 cm×6 cm). Subsequently, the cathode catalyst ink A was applied 9 times only onto the portion (6 cm×1.5 cm) which was to face the upstream of the fuel flow channel, to form a cathode catalyst layer. Except for the above, a comparative fuel cell 2 was produced in the same manner as in Example 1.

The amount of the Pt catalyst contained in the upstream portion of the cathode catalyst layer was 1.37 mg/cm², and the amount of the Pt catalyst contained in each of the midstream portion and the downstream portion of the cathode catalyst layer was 1.05 mg/cm².

The amount of the conductive carbon particles contained in the upstream portion of the cathode catalyst layer was 1.60 mg/cm², and the amount of the conductive carbon particles contained in each of the midstream portion and the downstream portion of the cathode catalyst layer was 1.23 mg/cm².

The amount of the polymer electrolyte contained in the upstream portion of the cathode catalyst layer was 0.64 mg/cm², and the amount of the polymer electrolyte contained in each of the midstream portion and the downstream portion of the cathode catalyst layer was 0.49 mg/cm².

### Comparative Example 3

A cathode catalyst ink F was prepared in the same manner as in Example 1 except that the weight ratio of the polymer electrolyte to the conductive carbon particles was set to 0.80.

Using the spray coater of FIG. 9, the cathode catalyst ink F was applied 35 times onto the whole power generation region (6 cm×6 cm) in the thickness direction thereof, to form a cathode catalyst layer. Except for the above, a comparative fuel cell 3 was produced in the same manner as in Example 1.

The amount of the Pt catalyst contained in the cathode catalyst layer was 1.23 mg/cm², the amount of the conductive carbon particle was 1.44 mg/cm², and the amount of the polymer electrolyte was 1.15 mg/cm².

### Comparative Example 4

A cathode catalyst ink G was prepared in the same manner as in Example 1 except that the weight ratio of the polymer electrolyte to the conductive carbon particles was set to 0.25.

Using the spray coater of FIG. 9, the cathode catalyst ink F was applied 35 times only onto the portion (6 cm×1.5 cm) which was to face the upstream of the fuel flow channel. Subsequently, the cathode catalyst ink G was applied 35 times onto the portion (6 cm×4.5 cm) which was to face the midstream and the downstream of the fuel flow channel, to form a cathode catalyst layer. Except for the above, a comparative fuel cell 4 was produced in the same manner as in Example 1.

The amount of the Pt catalyst contained in each of the upstream portion, the midstream portion, and the downstream portion of the cathode catalyst layer was 1.23 mg/cm².

The amount of the conductive carbon particles contained in each of the upstream portion, the midstream portion, and the downstream portion of the cathode catalyst layer was 1.44 mg/cm².

The amount of the polymer electrolyte contained in the upstream portion of the cathode catalyst layer was 1.15 mg/cm², and the amount of the polymer electrolyte contained in each of the midstream portion and the downstream portion was 0.36 mg/cm².

The durability of the fuel cells A to F produced in Examples 1 to 6 and the comparative fuel cells 1 to 4 produced in Comparative Examples 1 to 4 was evaluated in the following manner.

### (Durability)

An aqueous 4M methanol solution was supplied to the anode at a flow rate of 0.27 ml/min, while air was supplied to the cathode at a flow rate of 0.26 L/min. Under these conditions, each fuel cell was operated at a constant voltage of 0.4 V to generate power. The cell temperature during the power generation was set to 60° C.

The value of power density was calculated from the value of current density measured after four hours from the start of power generation. The obtained value was defined as initial power density.

Thereafter, from the value of current density measured after 2000 hours from the start of power generation, the value of power density was calculated. The ratio of the power density after 2000 hours to the initial power density was defined as power density retention rate.

Tables 1 and 2 show the initial power densities and power density retention rates obtained. In Tables 1 and 2, the power density retention rates are expressed as percentages.

Tables 1 and 2 also show the Pt catalyst amounts, the polymer electrolyte amounts, and the weight ratios (ratio W) of the polymer electrolyte to the conductive carbon particles in the respective portions of the cathode catalyst layer.

TABLE 1

| | | Cathode catalyst layer | | | | Durability | |
|---|---|---|---|---|---|---|---|
| | | | First | Second | | Initial power | Power density |
| | | Upstream | midstream | midstream | Downstream | density | retention |
| | Physical values | portion | portion | portion | portion | [mW/cm²] | rate [%] |
| Fuel cell A | Pt catalyst amount [mg/cm²] | 1.05 | 1.05 | 1.05 | 1.37 | 85 | 88 |
| | Polymer electrolyte weight [mg/cm²] | 0.49 | 0.49 | 0.49 | 0.64 | | |
| | Ratio W | 0.40 | 0.40 | 0.40 | 0.40 | | |
| Fuel cell B | Pt catalyst amount [mg/cm²] | 1.05 | 1.37 | 1.37 | 1.37 | 87 | 91 |
| | Polymer electrolyte weight [mg/cm²] | 0.49 | 0.64 | 0.64 | 0.64 | | |
| | Ratio W | 0.40 | 0.40 | 0.40 | 0.40 | | |
| Fuel cell C | Pt catalyst amount [mg/cm²] | 1.05 | 1.16 | 1.26 | 1.37 | 90 | 98 |
| | Polymer electrolyte weight [mg/cm²] | 0.49 | 0.54 | 0.59 | 0.64 | | |
| | Ratio W | 0.40 | 0.40 | 0.40 | 0.40 | | |
| Fuel cell D | Pt catalyst amount [mg/cm²] | 1.23 | 1.23 | 1.23 | 1.23 | 83 | 92 |
| | Polymer electrolyte weight [mg/cm²] | 0.50 | 0.50 | 0.50 | 0.86 | | |
| | Ratio W | 0.35 | 0.35 | 0.35 | 0.60 | | |
| Fuel cell E | Pt catalyst amount [mg/cm²] | 1.23 | 1.23 | 1.23 | 1.23 | 86 | 90 |
| | Polymer electrolyte weight [mg/cm²] | 0.50 | 0.86 | 0.86 | 0.86 | | |
| | Ratio W | 0.35 | 0.60 | 0.60 | 0.60 | | |
| Fuel cell F | Pt catalyst amount [mg/cm²] | 1.23 | 1.23 | 1.23 | 1.23 | 92 | 98 |
| | Polymer electrolyte weight [mg/cm²] | 0.50 | 0.58 | 0.72 | 0.86 | | |
| | Ratio W | 0.35 | 0.40 | 0.50 | 0.60 | | |

TABLE 2

| | | Cathode catalyst layer | | | | Durability | |
|---|---|---|---|---|---|---|---|
| | | | First | Second | | Initial power | Power density |
| | | Upstream | midstream | midstream | Downstream | density | retention |
| | Physical values | portion | portion | portion | portion | [mW/cm²] | rate [%] |
| Comparative fuel | Pt catalyst amount [mg/cm²] | 1.37 | 1.37 | 1.37 | 1.37 | 72 | 73 |
| cell 1 | Polymer electrolyte weight [mg/cm²] | 0.64 | 0.64 | 0.64 | 0.64 | | |
| | Ratio W | 0.40 | 0.40 | 0.40 | 0.40 | | |
| Comparative fuel | Pt catalyst amount [mg/cm²] | 1.37 | 1.05 | 1.05 | 1.05 | 64 | 76 |
| cell 2 | Polymer electrolyte weight [mg/cm²] | 0.64 | 0.49 | 0.49 | 0.49 | | |
| | Ratio W | 0.40 | 0.40 | 0.40 | 0.40 | | |
| Comparative fuel | Pt catalyst amount [mg/cm²] | 1.23 | 1.23 | 1.23 | 1.23 | 73 | 31 |
| cell 3 | Polymer electrolyte weight [mg/cm²] | 1.15 | 1.15 | 1.15 | 1.15 | | |
| | Ratio W | 0.80 | 0.80 | 0.80 | 0.80 | | |
| Comparative fuel | Pt catalyst amount [mg/cm²] | 1.23 | 1.23 | 1.23 | 1.23 | 52 | 42 |
| cell 4 | Polymer electrolyte weight [mg/cm²] | 1.15 | 0.36 | 0.36 | 0.36 | | |
| | Ratio W | 0.80 | 0.25 | 0.25 | 0.25 | | |

As shown in Table 1, the fuel cells A to F exhibited very high power density retention rates. In the invention, the amount of the polymer electrolyte contained in the upstream portion of the cathode catalyst layer was made smaller than that contained in the downstream portion of the cathode catalyst layer, as described above. Thus, in the cathode-side power generation region facing the upstream of the fuel flow channel with a large amount of MCO, it is possible to suppress a significant reduction in the pore volume of the catalyst layer due to swelling of the polymer electrolyte with crossover methanol. Also, it is possible to secure three-phase interface necessary for the reduction reaction of the oxidant and the oxidation reaction of the crossover methanol to proceed simultaneously. Further, in the cathode-side power generation region facing the downstream of the fuel flow channel with a small amount of MCO, the cathode layer has a structure capable of providing both good oxidant diffusion and good proton conductivity. Probably for these reasons, cathodic overvoltage was reduced and the durability of the fuel cells could be improved.

Also, when the amount of the polymer electrolyte contained in the upstream portion of the cathode catalyst layer is made smaller than that contained in the downstream portion thereof, and the weight ratio of the polymer electrolyte to the conductive carbon particles in the upstream portion of the cathode catalyst layer is made lower than that contained in the downstream portion thereof, an equivalent or greater effect can be obtained compared with when the amount of the polymer electrolyte contained in the cathode catalyst layer is changed.

Among the fuel cells A to F, the fuel cells C and F exhibited significantly improved durability. This is probably due to the following reason. In the case of the fuel cells C and F, the amount of the polymer electrolyte contained in the cathode catalyst layer or the ratio W is gradually (stepwise) changed from upstream toward downstream of the fuel flow channel. Thus, in the cathode catalyst layer, the polymer electrolyte amount or the ratio W is optimized according to the amount of MCO. In particular, in the midstream portion of the cathode catalyst layer, it is possible to suppress a decrease in the pore volume of the catalyst layer due to swelling of the polymer electrolyte, and ensure proton conductivity. As a result, cathodic overvoltage became small and stable.

On the other hand, the power density retention rates of the comparative fuel cells 1 to 4 were significantly lower than those of the fuel cells A to F. This is probably due to the following reason. In the case of the comparative fuel cells; the polymer electrolyte amount or the ratio W is large in the upstream portion of the cathode catalyst layer with a large amount of MCO. That is, the amount of the polymer electrolyte is excessive in the upstream portion of the cathode catalyst layer. In this case, the polymer electrolyte swells with crossover methanol, thereby significantly decreasing the pore volume of the upstream portion of the cathode catalyst layer. As a result, with the passage of power generation time, produced water accumulates in the upstream portion of the cathode catalyst layer, thereby making it difficult to supply the oxidant deep into the cathode catalyst layer in a reliable manner. As a result, the durability of the comparative fuel cells became poor.

Further, the comparative fuel cells 2 and 4 also exhibited low values for initial power density. This is probably due to the following reason. In the case of the comparative fuel cells 2 and 4, the polymer electrolyte amount or the ratio W in the downstream portion of the cathode catalyst layer is small, compared with the upstream portion of the cathode catalyst layer. Hence, it becomes difficult to obtain sufficient proton conductivity in the downstream portion of the cathode catalyst layer with a small amount of MCO, thereby resulting in the significantly low initial power density.

The direct oxidation fuel cell of the invention is excellent in power generation performance and durability, thus being useful as the power source for portable, small-sized electronic devices such as cell phones, notebook personal computers, and digital still cameras. Further, the direct oxidation fuel cell of the invention can also be used advantageously as the power source for, for example, electric scooters and automobiles.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. A direct oxidation fuel cell comprising at least: one unit cell, the unit cell including:
a membrane electrode assembly comprising an anode, a cathode, and an electrolyte membrane sandwiched between the anode and the cathode;
an anode-side separator being in contact with the anode and having a fuel flow channel for supplying a fuel to the anode; and
a cathode-side separator being in contact with the cathode and having an oxidant flow channel for supplying an oxidant to the cathode,
wherein the cathode includes a cathode catalyst layer in contact with the electrolyte membrane, and a cathode diffusion layer in contact with the cathode-side separator,
the cathode catalyst layer includes a cathode catalyst and a polymer electrolyte, and
the amount of the polymer electrolyte contained in a portion of the cathode catalyst layer facing an upstream portion of the fuel flow channel is smaller than that contained in a portion of the cathode catalyst layer facing a downstream portion of the fuel flow channel.

2. The direct oxidation fuel cell in accordance with claim 1, wherein the amount of the polymer electrolyte contained in the cathode catalyst layer gradually increases from upstream toward downstream of the fuel flow channel.

3. The direct oxidation fuel cell in accordance with claim 1, wherein the cathode catalyst layer includes conductive carbon particles loaded with the cathode catalyst, and the weight ratio of the polymer electrolyte to the conductive carbon particles in the portion of the cathode catalyst layer facing the upstream portion of the fuel flow channel is lower than that in the portion of the cathode catalyst layer facing the downstream portion of the fuel flow channel.

4. The direct oxidation fuel cell in accordance with claim 3, wherein the weight ratio of the polymer electrolyte to the conductive carbon particles gradually increases in the cathode catalyst layer from upstream toward downstream of the fuel flow channel.

5. The direct oxidation fuel cell in accordance with claim 3, wherein the weight ratio of the polymer electrolyte to the conductive carbon particles is from 0.3 to 0.6 in the portion of the cathode catalyst layer facing the upstream portion of the fuel flow channel.
